(19) United States
(12) Patent Application Publication
(10) Pub. No.: US 2018/0098653 A1
(43) Pub. Date: Apr. 12, 2018

(54) Magnetic Base Beverage Container

(71) Applicant: Leonard Pinchuk, Miami, FL (US)

(72) Inventor: Leonard Pinchuk, Miami, FL (US)

(21) Appl. No.: 15/561,302

(22) PCT Filed: Mar. 25, 2016
(86) PCT No.: PCT/US16/24198

§ 371 Date: Sep. 25, 2017

Related U.S. Application Data
(60) Provisional application No. 62/140,581, filed on Mar. 31, 2015.

(51) Int. Cl. A47G 23/02; A47G 19/22; F16B 1/00; F16B 11/00; A47B 77/02

(52) U.S. Cl. CPC A47G 23/0208; A47G 19/2261; F16B 2001/0035; F16B 11/006; A47B 77/02; F16B 1/00

(57) ABSTRACT

A method of making beverage container (such as a wineglass, a stemless wineglass, a beer mug or the like) having a magnet adhesively affixed to the bottom of the beverage container. The magnetic base beverage container can be used in combination with a metal strip to support the magnetic base beverage container by attraction of the magnet to the metal support. The method includes providing a base and a drinking glass, coupling at least one magnet to the base forming an assembly, and attaching the assembly to a bottom surface of the drinking glass. Attaching the assembly to a bottom surface of the drinking glass includes applying a waterproof adhesive to one or both of the assembly and the the the bottom surface of the drinking glass and applying sufficient pressure between the assembly and the drinking glass to spread the adhesive as a layer over at least part of an upper surface of the assembly.

### CROSS-REFERENCE TO RELATED APPLICATIONS

This application is the non-provisional of, and claims priority under 35 U.S.C. 119(e) to, U.S. Application No. 62/140,581, filed on Mar. 31, 2015, the entire content of which is incorporated herein by reference.

### BACKGROUND

### 1. Field

The present application pertains to a magnetic-based drinking glass, for example a water glass, a beer mug, a wineglass and the like.

### 2. State of the Art

Conventional stemmed wine glasses suffer from not fitting efficiently into dish washers. Further, when placed in a dishwasher, they are often unstable and can move and angulate due to the force of the circulating water. If angled incorrectly, the wineglass can partially fill with water and when dried, the evaporating water can deposit salt residues which spot and cloud the glass. Stemmed wineglasses are also often hung upside down under cabinets to allow water to drain from the glass, whereas if allowed to dry standing upright, the salts in the water that precipitate from the evaporating water causes spotting on the glass. Lastly, stemmed wineglasses are unstable; that is, you can't leave them on a curved or inclined surface, such as the roof or trunk of a car for a tailgate party, without risking them falling over.

As a result, the stemless wine glass has become popular as they readily fit into dishwashers. However, stemless wine glasses suffer from not being able to be hung upside down to dry, they clutter cabinets and they also fall off of car roofs.

### SUMMARY

The present disclosure describes a method of adhesively affixing a magnet to the bottom of a beverage container (such as a wineglass, a stemless wineglass, a beer mug or the like). The magnetic base beverage container can be used in combination with a metal strip support (or other metal structure) to support the magnetic base beverage container by attraction of the magnet to the metal support. In one embodiment, the metal strip support can be fastened under a cabinet to allow the magnetic based beverage containers to be supported upside down under the cabinet. Storing the beverage containers in this manner, can reduce cabinet clutter and allow water used to wash the containers to drain from the containers to avoid spotting. The magnetic base beverage container also attaches well to the roof and trunk of cars and trucks. This magnetic base drinking container can also be attracted to metal strips placed strategically in vehicles, including automobiles, boats, and airplanes to prevent spillage of liquid from the container. Metal strips can also be placed on carrying trays, music stands, swings, lawn chairs, arm chairs and the like.

### BRIEF DESCRIPTION OF THE DRAWINGS

FIG. 1 shows upper and side views of a disk having a well that receives a magnet (FIGS. 2 and 3); the disk is secured to the bottom surface of a beverage container (FIGS. 4 and 5).

FIG. 2 shows upper and side views of a magnet that is positioned within the well of the disk (FIG. 3) that is secured to the bottom surface of a beverage container (FIGS. 4 and 5).

FIG. 3 shows upper and side views of an assembly formed by the magnet of FIG. 2 positioned within the well of the disk of FIG. 1.

FIG. 4 shows a side view of a stemless wineglass beverage container.

FIG. 5 shows a side view of the assembly of FIG. 3 that is secured to the bottom surface of the beverage container of FIG. 4 by an adhesive coating.

FIG. 5a shows a detailed view of the assembled magnetic base beverage container of FIG. 5 viewed along section 5a-5a in FIG. 5.

FIG. 6 shows two rows of magnetic base stemless wineglass beverage containers supported under a cabinet.

FIG. 7 shows a row of four magnetic base stemless wineglass beverage containers adhering to the metal casing on a lamp secured underneath a cabinet.

FIG. 8 shows a workflow of making a magnetic base beverage container.

FIG. 9 shows another workflow of making a magnetic base beverage container.

### DETAILED DESCRIPTION

The present disclosure describes a magnet adhesively fastened to the bottom of the beverage container. The exemplary beverage container described hereinbelow is a stemless wineglass, although other beverage containers may be used as well, such as a stemmed wineglass, a beer glass, champagne glass, a beer mug, a bowl, or the like. The magnetic base beverage container can be used in combination with a metal strip support (or other metal structure) to support the magnetic base beverage container by attraction of the magnet to the metal support. In one embodiment, the metal strip support can be fastened under a cabinet to allow the magnetic based beverage containers to be supported upside down under the cabinet. Storing the beverage containers in this manner, can reduce cabinet clutter and allow the water to drain from the containers to avoid spotting. The magnetic base beverage container also sticks well to the roof and trunk of cars and trucks. This magnetic base drinking container can also be attracted to metal strips placed strategically in vehicles, including boats such as are coffee cup holders and the like to prevent spilling. The metal strip can also be placed vertically on a wall or stand to store the container. Also, the metal strip itself can also be a magnet placed with the proper polarity such that it attracts the magnet on the magnetic based container.

Referring to FIG. 1, a disk 1 (clear or opaque) is injection molded or cut from an acrylic sheet of Plexiglas® (not shown). The disk 1 may also be made of polycarbonate, polyacetal, polyimide, polysulfone, polyurethane, fluoropolymers, polyolefins (polypropylene, polyethylene, etc.) or other plastic material. The disk 1 can be laser cut from the Plexiglas® sheet. In this manner the edges are inherently polished. Alternatively, the disk 1 can be formed by injection molding of Plexiglas® or other plastic into a polished mold. The disk thus formed may be roughened and/or treated with a chemical primer to enable adhering an adhesive to the disk. In one embodiment, the disk 1 can be 0.12 inches thick and 1.5 inches in diameter. The diameter of the disk 1 may be sized based on the type of drinking glass it is used with. For example, for a wine glass, the disk may be 1.5 inches in diameter, while for a beer mug, the disk may be 2 inches or larger in diameter.

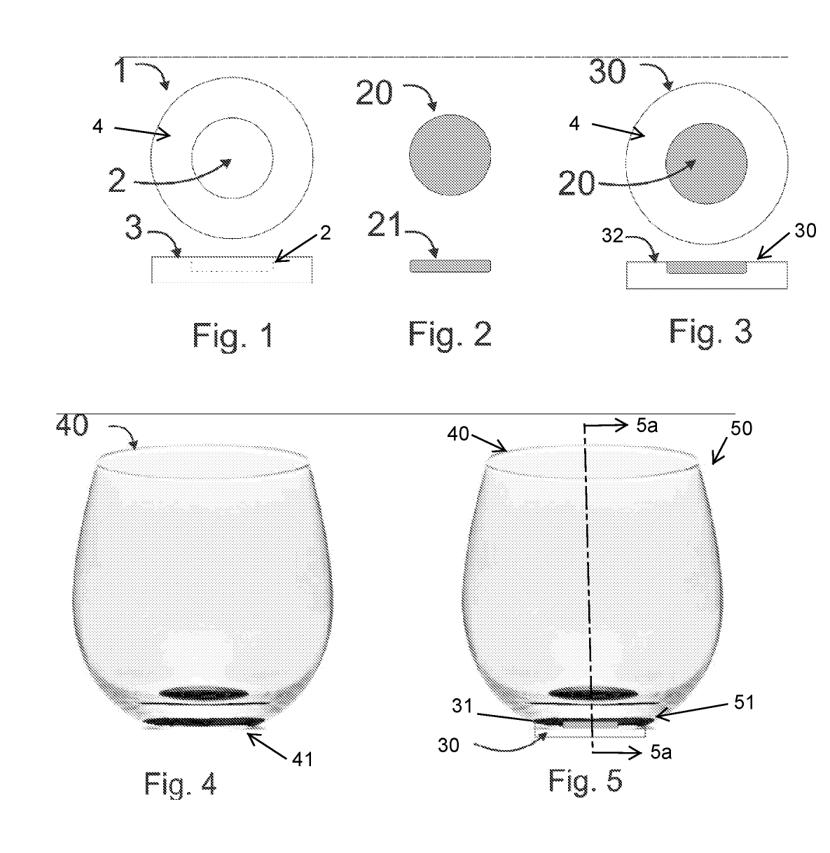

A well 2 is machined or formed (e.g., molded) into the disk 1, generally at the center of the disk 1, as shown in FIG. 1. In one embodiment, the well 2 can be 0.76 inches in diameter and 0.12 inch deep. A magnet 20 is provided as shown in FIG. 2. The magnet 20 is placed in the well 2 in the disk 1 to form a disk-magnet assembly 30 as shown in FIG. 3. The thickness of the magnet 20 may be equal to, but preferably less than, the depth of the well 2 such that an upper surface of the magnet 20 is flush with an upper annular surface 4 of the disk 1 surrounding the magnet 20. An attachment surface 32 of the assembly 30 may be formed by the upper annular surface 4 of the disk 1 and possibly the upper surface of magnet 20. In one embodiment, the magnet 20 can be formed from rare earth material such as neodymium and can be 0.75 inches in diameter and 0.100 inch thick. The assembly 30 is placed with the magnet 20 facing upward as shown in FIG. 3.

Magnets readily corrode in the presence of water due to their high iron content. It is therefore advantageous to protect the magnet 20 from interfacing water, especially if placed in a dishwasher. The bottom and annular end of the magnet 20 can be coated or encapsulated with a corrosion-preventing coating (such as a water-proof polymer) before the magnet 20 is placed in the well 2 of the disk 1. Examples of such polymers include fluoropolymers like Teflon, paralene, polycarbonate, acrylics, polyurethane, polyolefins, polyesters, polyimides, polyacetals, etc. An epoxy polymer 31 adhesive can be dispensed over the annular surface 4 of the disk 1 surrounding the well 2 and possibly over the upper surface of the magnet 20. In one embodiment, the epoxy polymer adhesive 31 can be waterproof when cured to prevent exposure of the magnet 20 to water. For example, the epoxy polymer adhesive can be Loctite® Epoxy Instant Mix™ 5 Minute made by Henkel Corporation of Westlake, Ohio. Alternatively the adhesive can be polyurethane; specifically a hydrolytically stable polyurethane such as polyether urethane. The adhesive can also be a non-corrosive silicone polymers such as methoxy or ethoxy dimethylsiloxane or diphenyl siloxane. The adhesive can also be a hydrolytically stable cyanoacrylate, such as butyl, pentyl or hexyl dicyanoacrylate. These polymer adhesives can be used to trap or encapsulate the magnet 20 between the bottom surface 41 of the wineglass 40 and the disk 1. The magnet 2 may also be painted or otherwise colorized to match the color of the disk 1 or glass 40 so that the presence of the magnet 20 is camouflaged.

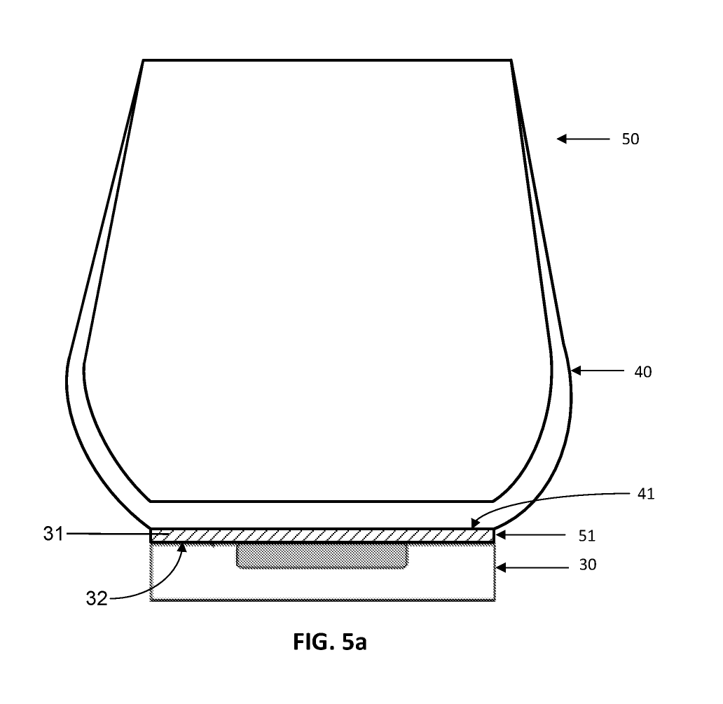

A beverage container 40, embodied as a stemless wineglass with a flat bottom attachment surface 41, is provided as shown in FIG. 4. The flat bottom attachment surface 41 can be roughened, such as by chemical etching, laser etching or sanding, for example. The flat bottom attachment surface 41 can be configured to be complementary to the attachment surface 32 of the assembly 30. Other (non-flat) complementary attachment surfaces of the wineglass 40 and the assembly 30 can also possibly be used. The wineglass 40 is placed over and onto the epoxy polymer adhesive and sufficient pressure exerted on the wineglass 40 such that the epoxy polymer adhesive 31 spreads over the upper annular surface 4 of the disk 1 and possibly over the upper surface of the magnet 20. In one embodiment, the epoxy polymer adhesive 31 can spread over the entire upper surfaces of the disk 1 and the magnet 20. The epoxy polymer adhesive 31 is allowed to cure to adhesively attach the assembly 30 the bottom attachment surface 41 and thus form the resultant magnetic base wineglass 50 as shown in FIG. 5. The cured epoxy polymer adhesive 31 can also form a liquid tight seal at the interface between the bottom attachment surface 41 of the wineglass 40 and the upper annular surface 4 of the disk 1 as shown in FIG. 5a. The liquid tight seal can also extend to fill all or part of the interface between the bottom attachment surface 41 of the wineglass 40 and the upper surface of the magnet 20 as shown. The magnet 20 is thereby captured or trapped in a liquid tight manner in the well 2 of the disk 1 by the cured epoxy polymer adhesive 31. In this configuration, the cured epoxy polymer adhesive 31 seals the magnet 20 within the well 2 of the disk 1 and acts as a water-proof boundary that prevents water from reaching the magnet 20 and thus protects the magnet 20 against corrosion in the presence of water (such as in a dishwasher). Magnetic base wineglasses 50, as well as other types of magnetic base beverage containers, can be made in this manner.

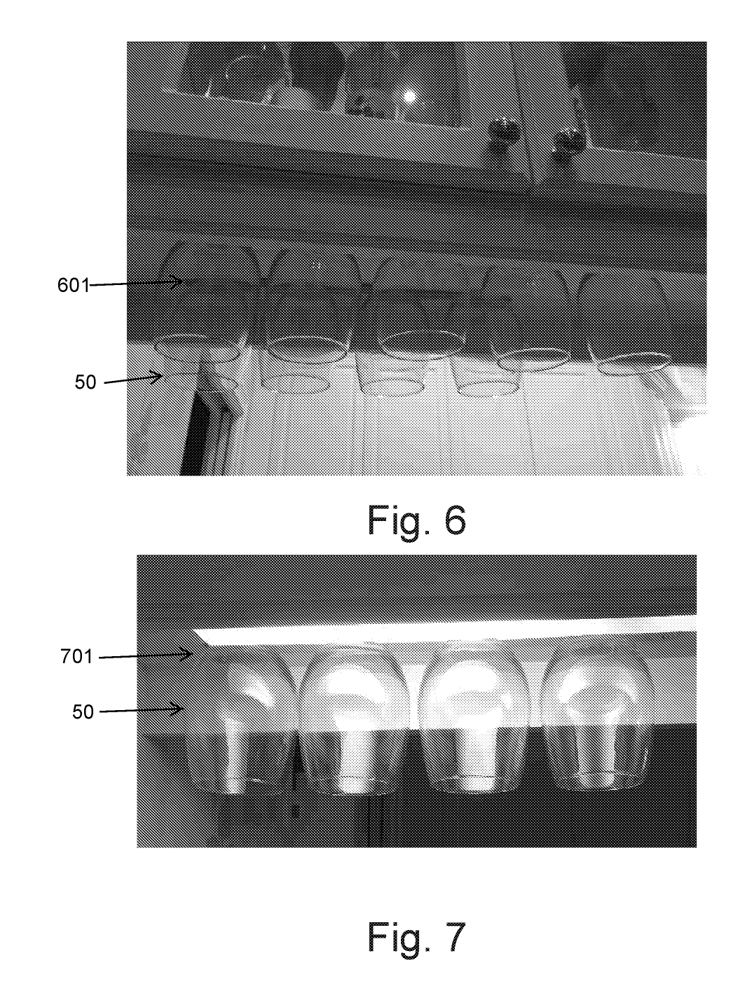

FIG. 6 shows a metal strip 601, which may be provided in a kit with one or more magnetic base glasses 50. The metal strip 601 may be magnetic or non-magnetic. The metal strip 601 may be fastened under a cabinet or other structure. The magnetic base wineglasses can then be attached to the strip of metal by magnetic forces provided by the magnetic bases of such wineglasses as shown in FIG. 6.

The metal strip 601 has a width that is at least equal to the diameter of the magnet 20. In one embodiment, the metal strip 601 has a width that is wider than the diameter of the magnet 20 and is equal to the diameter of the disk 1 in order to provide additional stability to the magnetic base wineglasses 50 when they are attached to the metal strip 601, as shown in FIG. 6.

The metal strip 601 may have a length to hold a plurality of magnetic base wineglasses 50 in a row. Note that FIG. 6 shows two strips of metal forming two rows of magnetic base wineglasses supported under a cabinet. In one embodiment, the length of the metal strip 601 is equal to a multiple of the diameter of the magnetic base wineglasses 50. For example, in a case where the magnetic base wineglasses 50 have a diameter of 3 inches, the strip of metal may have a length of 12 inches (to support 4 magnetic base wineglasses 50) or 18 inches (to support 6 magnetic base wineglasses 50). Although FIG. 6 shows two strips to hold two rows of magnetic based wineglasses, one could also use one strip that is 6″ wide and sufficiently long to accomplish the same.

FIG. 7 shows a row of four magnetic base wineglasses 50 magnetically attached to a metal casing 701 of a light fixture that is secured underneath a cabinet. An independent metal strip 601 is not necessary in this case because the metal casing 701 substitutes for the metal strip 601.

The magnet 20 described herein can be any type of magnet, such as, for example, rare earth magnets like neodymium and samarium-cobalt magnets. The magnet 20 can be attached to the base of a beverage container in a manner such that the container will not fall over. Therefore, if a single disk-shaped magnet 20 is used, a diameter of the magnet 20 may be less than the diameter of the disk 1 to provide an annular surface 4 of the disk 1 around the magnet 20 for adhesion of the disk 1 to the glass 40. Also, the diameter and thickness of the magnet 20 are sized to limit the strength of the magnet 20 so that the magnet 20 will not favor adhering to the metal (e.g., metal strip 601) it is attracted to, which could risk delaminating the disk 1 from the glass 40 when the magnetic base wineglass 50 is pulled away from the metal.

Moreover, the diameter and thickness of the magnet 20 may be selected based upon the thickness of the portion of the disk 1 through which the magnetic field passes. If such portion is too thick for the magnetic field of the magnet 20 to penetrate, then the glass 40 will not be adequately magnetically attracted to the metal (e.g., metal strip 601). In one embodiment, the thickness of the portion of the disk 1 below the well 2 is about 0.015 to 0.030 inch thicker than the thickness of the magnet 20. By way of example, the magnet 20 may have a diameter of about 0.75 inch and a thickness of about 0.100 inch and the total thickness of the disk 1 is 0.120 inch, with a well depth of 0.105, which results in a wall thickeness below the bmagent of 0.015″

While the examples above describe the use of a single cylindrical magnet, it will be appreciated that a plurality of smaller magnets dispersed over the base of the glass may also be used for the purpose of the present disclosure. For example, four smaller magnets (for example, magnets that are 0.25 inches in diameter and 0.060 inches thick) can be used with the magnets placed ninety degrees apart on opposite diameters of the flat bottom surface of the wineglass 40. These magnets can be placed in small wells in a machined disk similar to disk 1.

Moreover, while the magnet 20 has been described above used in conjunction with a disk 1, it will be appreciated that the magnet 20 can alternatively be adhered directly to the bottom of the glass 40 with epoxy, polyurethane, silicone or cyanoacrylate polymer adhesives and without the disk 1.

Further, the magnetization of the magnet 20 and the metal strip 601 may be reversed so that, at least in one alternative embodiment, the metal strip 601 is magnetic, while the magnet 20 is a non-magnetic metal disk.

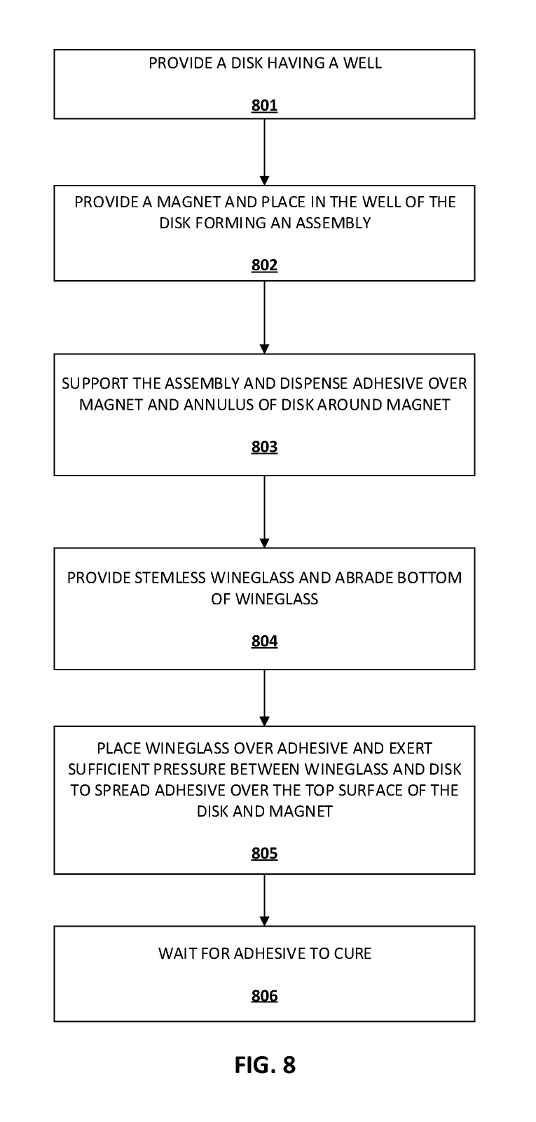

A workflow of a method of making the magnetic base wineglass 50 will now be described with reference to FIG. 8. At step 801 a disk 1 is provided having a well 2 that is machined or formed (e.g., molded) into the disk 1. At step 802 a magnet 20 is provided and placed in the well 2 of the disk 1 forming a disk-magnet assembly 30. Magnet 20 may or may not be adhered to the well 2 in disk 1. At step 803 the assembly 30 is placed on a support with the magnet facing upward and the epoxy polymer adhesive 31 is dispensed over the annular surface 4 of the disk 1 and possibly over the magnet 20. It may at times be necessary at step 803 to remove bubbles from the adhesive by placing it under vacuum or allowing time for the bubbles to dissipate. At step 804 the stemless wineglass 40 with flat bottom attachment surface 41 is provided and the attachment surface 41 is roughened, such as by chemical etching, laser etching or sanding, for example. At step 805 the attachment surface 41 of the wineglass 40 is placed over the epoxy polymer adhesive 31 and sufficient pressure exerted on the wineglass 40 such that the epoxy polymer adhesive 31 spreads over the annular surface 4 of the disk 1 and possibly the magnet 2. At step 806 the epoxy polymer adhesive 31 is allowed to cure and form a liquid tight seal 51 at the interface between the bottom attachment surface 41 of the wineglass 40 and the upper annular surface 4 of the disk 1 as shown in FIG. 5a. The liquid tight seal 51 can also extend to fill all or part of the interface between the bottom attachment surface 41 of the wineglass 40 and the upper surface of the magnet 20 as shown. The magnet 20 is thereby trapped in a liquid tight manner in the well 2 of the disk 1 by the cured epoxy polymer adhesive 31. It will also be appreciated that the assembly could be clamped to maintain alignment of the disk with the glass. The assembly can also be heated to hasten the cure.

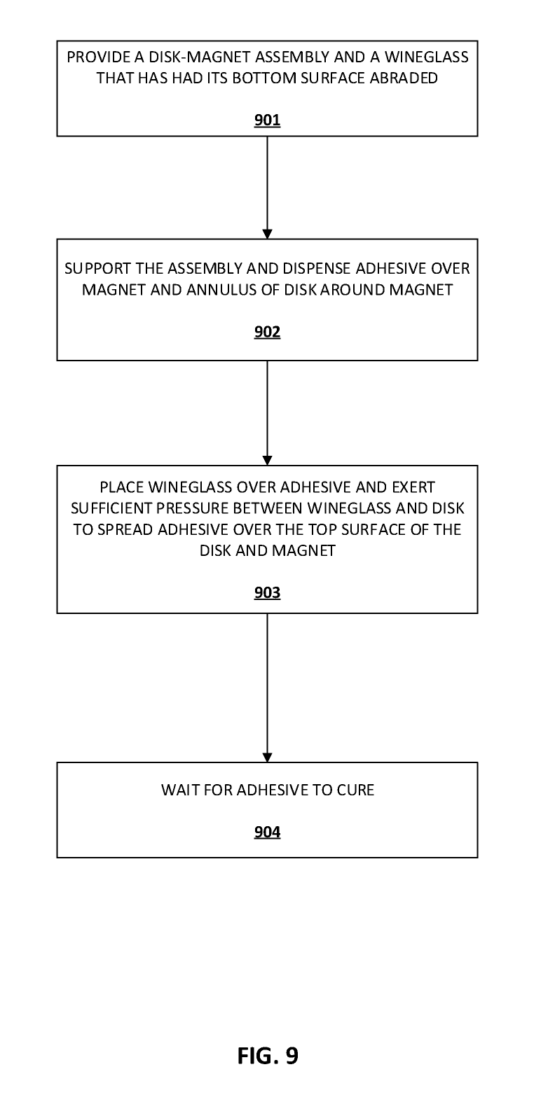

It will be appreciated that adjustments or simplifications to the workflow of FIG. 8 may be made, such as by combining steps to form subassemblies which are assembled together. For example, in an alternate workflow shown in FIG. 9, at step 901 assembly 30 and wineglass 40 are provided, with wineglass 40 having had its bottom attachment surface 41 roughened, such as by chemical or laser etching or sanding. At step 902 the assembly 30 is placed on a support with the magnet 20 facing upward and the epoxy polymer adhesive 31 is dispensed over the annular surface 4 of the disk 1 and possibly the magnet 20. At step 903 the attachment surface 41 of the wineglass 40 is placed over the epoxy polymer adhesive 31 and sufficient pressure exerted on the wineglass 40 such that the epoxy polymer adhesive 31 spreads over the annular surface 4 of the disk 1 and possibly the upper surface of the magnet 20. At step 904 the epoxy polymer adhesive is allowed to cure and form a liquid tight seal 51 at the interface between the bottom attachment surface 41 of the wineglass 40 and the upper annular surface 4 of the disk 1 as shown in FIG. 5a. The liquid tight seal 51 can also extend to fill all or part of the interface between the bottom attachment surface 41 of the wineglass 40 and the upper surface of the magnet 20 as shown. The magnet 20 is thereby trapped in a liquid tight manner in the well 2 of the disk 1 by the cured epoxy polymer adhesive 31.

There have been described and illustrated herein several embodiments of a magnetic base beverage container and support systems for such beverage containers. While particular embodiments of the invention have been described, it is not intended that the invention be limited thereto, as it is intended that the invention be as broad in scope as the art will allow and that the specification be read likewise. It will therefore be appreciated by those skilled in the art that yet other modifications could be made to the provided invention without deviating from its spirit and scope as claimed.

1. A method of making a beverage container for use with a fixed metal fixture, the method comprising:
providing a base and a drinking glass having at least one bottom attachment surface;
coupling at least one magnet to the base forming an assembly; and
adhesively attaching at least one attachment surface of the base of the assembly to the at least one bottom attachment surface of the drinking glass,
wherein coupling the magnet to the base includes placing the magnet in a well formed in the base, the well being surrounded by an annular attachment surface of the base.

2. The method according to claim 1, wherein:
the drinking glass is one of a stemless wineglass, a stemmed wine glass, champagne glass, beer glass, or beer mug.

3. (canceled)

4. The method according to claim 1, wherein:
the magnet is adhesively attached to the well.

5. The method according to claim 4, further comprising:
applying primer to the well.

6. The method according to claim 1, wherein: the base is a disk.

7. The method according to claim 1, wherein:
adhesively attaching the at least one attachment surface of the assembly to the at least one bottom attachment surface of the drinking glass includes applying a waterproof adhesive to the at least one attachment surface of the assembly and/or the least one bottom attachment surface of the drinking glass and applying sufficient pressure between the assembly and the drinking glass to spread the adhesive as a layer over the at least one attachment surface of the assembly, and wherein the layer of adhesive seals the magnet between the assembly and the drinking glass.

8. The method according to claim 7, wherein:
the waterproof adhesive includes a waterproof polymer selected from the group including epoxy, polyurethane, silicone and cyanoacrylate polymer adhesives.

9. The method according to claim 7, further comprising:
curing the adhesive.

10. The method according to claim 1, further comprising:
roughening the bottom attachment surface of the drinking glass before attaching the drinking glass to the assembly.

11. The method according to claim 7, wherein:
roughening includes at least one of chemical or laser etching and sanding.

12. The method according to claim 1, wherein the at least one attachment surface of the assembly and the at least one bottom attachment surface of the drinking glass are complementary mating surfaces.

13. The method according to claim 1, further comprising:
applying primer to the at least one attachment surface of the assembly.

14. A magnetic drinking glass kit comprising:
a magnetic drinking glass comprised of a drinking glass and a magnetic base attached to a bottom surface of the drinking glass, the magnetic base including a disk containing a magnet, the drinking glass having a first diameter, the disk having a second diameter, and the magnet having a third diameter; and
a metal strip configured to be mounted to a support and to magnetically attach to the magnetic base of the magnetic drinking glass, wherein the metal strip has a width at least equal to the third diameter.

15. The magnetic drinking glass kit of claim 14, wherein:
the metal strip has a length equal to a multiple of the first diameter.

16. The magnetic drinking glass kit of claim 14, wherein:
the metal strip has a width between the third diameter and the second diameter.

17. The magnetic drinking glass kit of claim 14, wherein:
the metal strip is magnetic.

18. The magnetic drinking glass kit of claim 14, wherein:
the metal strip is configured to mount to the underside of cabinets.

19. The magnetic drinking glass kit of claim 14, wherein the metal strip is configured to to suspend the magnetic drinking glass upside down or secure the magnetic drinking glass right side up.

20. A method of making a beverage container for use with a fixed metal fixture, the method comprising:
providing a magnetic base having a disk containing a magnet;
providing a drinking glass having a bottom surface; and
adhesively attaching the magnetic base to the bottom surface of the drinking glass, forming a fluid-tight seal around the magnet,
wherein attaching the magnetic base to the bottom of the drinking glass includes applying a waterproof adhesive to one or both of the magnetic base and the bottom of the drinking glass and applying sufficient pressure between the assembly and the drinking glass to spread the adhesive as a layer over an upper surface of the assembly, wherein the layer of adhesive seals the magnet between the disk and the drinking glass, and
wherein the waterproof adhesive includes a waterproof polymer selected from the group including epoxy, polyurethane, silicone and cyanoacrylate polymer adhesives.

21.-22. (canceled)

23. The method according to claim 20, further comprising:
roughening the bottom surface of the drinking glass before attaching the drinking glass to the magnetic base.
